(19) United States
(12) Patent Application Publication
(10) Pub. No.: US 2026/0274460 A1
(43) Pub. Date: Sep. 17, 2026

(54) UNMANNED AERIAL VEHICLE

(71) Applicant: AUTEL ROBOTICS CO., LTD., Shenzhen, Guangdong (CN)

(72) Inventors: Zhuanpeng CHENG, Shenzhen (CN); Ao HE, Shenzhen (CN); Lei LEI, Shenzhen (CN); Kangli WANG, Shenzhen (CN)

(73) Assignee: AUTEL ROBOTICS CO., LTD., Shenzhen, Guangdong (CN)

(21) Appl. No.: 19/094,797

(22) Filed: Mar. 28, 2025

(30) Foreign Application Priority Data
Apr. 1, 2024 (CN) 202410390985.7

(51) Int. Cl. B64U 20/92; B64U 20/96; B64U 10/20

(52) U.S. Cl. CPC B64U 20/92; B64U 20/96; B64U 10/20

(57) ABSTRACT

An unmanned aerial vehicle (UAV) is disclosed, including a fuselage, a wing assembly, and a heat dissipation structure. The heat dissipation structure and the wing assembly are both mounted to the fuselage. The heat dissipation structure is thermally connected to at least some electronic devices within the fuselage. The fuselage and the wing assembly together define a heat dissipation channel in communication with the external environment. At least a portion of the heat dissipation structure is exposed to the heat dissipation channel, allowing external airflow to cool the heat dissipation structure during UAV flight. Through this structure, the heat generated by the electronic devices is transferred to the heat dissipation structure and exchanged with the outside air, thereby enhancing cooling efficiency and ensuring reliable operation of the UAV.

### CROSS-REFERENCE TO RELATED APPLICATION

This application claims priority of Chinese Patent Applicant No. 202410390985.7, filed on April 01, 2024, entitled as “UNMANNED AERIAL VEHICLE,” the entire disclosure of which is incorporated herein by reference for all purposes.

### TECHNICAL FIELD

Embodiments of the disclosure relate to the technical field of unmanned aerial vehicles (UAVs), and in particular, to a UAV.

### BACKGROUND

Many electronic devices that easily generate heat are arranged inside an unmanned aerial vehicle (UAV), for example, a radio frequency chip and a control chip. To ensure normal operation of these electronic devices, a heat dissipation structure needs to be arranged to dissipate heat of the electronic devices that easily generate heat.

Currently, a commonly used heat dissipation method is to arrange a cooling fan inside the UA and blow air to the electronic devices through the cooling fan, thereby accelerating heat dissipation of the electronic devices.

However, since the cooling fan and the electronic devices are arranged inside the UAV, and air inside the UAV does not circulate with outside air, it is difficult for the electronic devices inside the UAV to exchange heat with the outside air, resulting in a poor heat dissipation effect.

### SUMMARY

An unmanned aerial vehicle (UAV) is disclosed, comprising a fuselage, a wing assembly, and a heat dissipation structure. The heat dissipation structure and the wing assembly are both mounted to the fuselage. The heat dissipation structure is thermally connected to at least some electronic devices within the fuselage. The fuselage and the wing assembly define a heat dissipation channel in fluid communication with an external environment. At least a portion of the heat dissipation structure is exposed to the heat dissipation channel, enabling external air passing through the heat dissipation channel during flight to cool the heat dissipation structure.

The heat dissipation structure is thermally connected to at least some electronic devices within the fuselage, with at least part of the heat dissipation structure exposed to the heat dissipation channel, which is in communication with the external environment. Heat generated by the electronic devices is transferred to the heat dissipation structure. During UAV flight, external air flows through the heat dissipation channel and removes at least a portion of the heat from the heat dissipation structure, thereby facilitating heat exchange between the electronic devices and the external air and improving overall heat dissipation efficiency.

In some embodiments, the heat dissipation channel comprises an air venting channel and a first air intake channel. The first air intake channel is in fluid communication with the air venting channel, and the heat dissipation structure is positioned within the air venting channel. An air inlet of the first air intake channel is in fluid communication with the external environment, and the air inlet is oriented toward the front of the UAV. This configuration allows external air to enter the first air intake channel as the UAV moves forward.

In some embodiments, the heat dissipation structure comprises a heat dissipation plate and at least one heat dissipation fin. The heat dissipation plate is mounted to the fuselage and thermally connected to at least some electronic devices within the fuselage. At least a portion of the heat dissipation plate is exposed to the air venting channel. The at least one heat dissipation fin is mounted on a surface of the heat dissipation plate facing the heat dissipation channel.

In some embodiments, a plurality of heat dissipation fins are provided and distributed at intervals along a first direction, wherein the first direction is not parallel to a flow direction of air in the air venting channel. This arrangement reduces the likelihood of airflow obstruction between adjacent fins, thereby improving heat dissipation efficiency.

In some embodiments, the wing assembly comprises a wing body and a first enclosing plate. The wing body is mounted to the fuselage, and the first enclosing plate is mounted to the wing body. The first enclosing plate and the wing body collectively define at least part of the boundary of the first air intake channel.

In some embodiments, the heat dissipation channel further comprises a second air intake channel in fluid communication with the air venting channel. An air inlet of the second air intake channel is in fluid communication with the external environment and is oriented toward the front of the UAV. The first air intake channel and the second air intake channel are located on opposite sides of the fuselage. This configuration allows external air to enter the air venting channel from both air intake channels, thereby improving the heat dissipation efficiency of the heat dissipation structure.

In some embodiments, the wing assembly further comprises a second enclosing plate. The wing body and the second enclosing plate collectively define at least part of the boundary of the second air intake channel.

In some embodiments, the heat dissipation structure further comprises a first flow guide plate located within the air venting channel. One end of the first flow guide plate is joined to an air outlet of the first air intake channel, directing at least a portion of the air from the first air intake channel into the air venting channel. This arrangement reduces airflow turbulence within the air venting channel and stabilizes airflow rates, ensuring efficient heat dissipation.

In some embodiments, the heat dissipation structure further comprises a second flow guide plate positioned opposite the first flow guide plate. One end of the second flow guide plate is joined to an air outlet of the second air intake channel, directing at least a portion of the air from the second air intake channel into the air venting channel. This configuration further reduces turbulence and improves heat dissipation efficiency.

In some embodiments, a distance between the first flow guide plate and the second flow guide plate gradually increases from one end to the other. This arrangement further stabilizes airflow within the air venting channel, minimizing turbulence and improving the overall heat dissipation effect.

The disclosed embodiments provide advantages over prior art solutions. Unlike conventional UAV designs, the disclosed UAV integrates a heat dissipation structure thermally connected to at least some electronic devices within the fuselage. At least a portion of the heat dissipation structure is exposed to a heat dissipation channel in fluid communication with the external environment. During UAV flight, external air flows through the heat dissipation channel, removing heat from the heat dissipation structure and facilitating efficient heat exchange. The combination of air intake channels, heat dissipation fins, and flow guide plates enhances cooling efficiency and ensures stable thermal management of onboard electronic devices.

### BRIEF DESCRIPTION OF THE DRAWINGS

In order to more clearly describe the technical solutions in specific embodiments of the disclosure or in the prior art, the accompanying drawings required for describing the specific embodiments or the prior art are briefly described below. In all of the accompanying drawings, similar elements or parts are generally marked by similar reference numerals. In the accompanying drawings, each element or part is not necessarily drawn to actual scale.

FIG. 1 is a schematic structural diagram of an unmanned aerial vehicle (UAV) according to an embodiment of the disclosure.

FIG. 2 is an enlarged view of a region shown in part A in FIG. 1.

FIG. 3 is a partial schematic structural diagram of a UAV in a disassembled state according to an embodiment of the disclosure.

FIG. 4 is an enlarged view of a region shown in part B in FIG. 3.

FIG. 5 is a partial schematic structural diagram of a wing assembly and a heat dissipation structure in a disassembled state according to an embodiment of the disclosure.

FIG. 6 is a partial schematic structural diagram of a UAV according to an embodiment of the disclosure.

FIG. 7 is a partial schematic structural diagram of a UAV according to an embodiment of the disclosure when a first driving assembly and a second driving assembly are both in a horizontal state.

FIG. 8 is an enlarged view of a region shown in part D in FIG. 7.

FIG. 9 is a partial schematic structural diagram of a wing assembly according to an embodiment of the disclosure.

FIG. 10 is an enlarged view of a region shown in part C in FIG. 9.

### DETAILED DESCRIPTION

The present disclosure is described in detail below with reference to the accompanying drawings and specific embodiments. When an element is described as being "fixed to" another element, it may be directly on the other element or connected through one or more intermediate elements. Similarly, when an element is described as being "connected to" another element, it may be directly connected or connected via one or more intermediate elements. Terms indicating orientation or positional relationships such as "up," "down," "inside," "outside," "perpendicular," and "horizontal" are based on the orientation depicted in the accompanying drawings and are used for ease of description rather than as limitations. Such terms should not be construed to require a particular orientation of the described apparatus or components. Terms like "first" and "second" are used for differentiation rather than to indicate relative importance. Unless otherwise defined, all technical and scientific terms used herein carry the same meanings as those typically understood by those skilled in the relevant art. The term "and/or" encompasses any or all combinations of one or more of the associated listed items. Technical features from different embodiments may be combined as long as no conflicts arise.

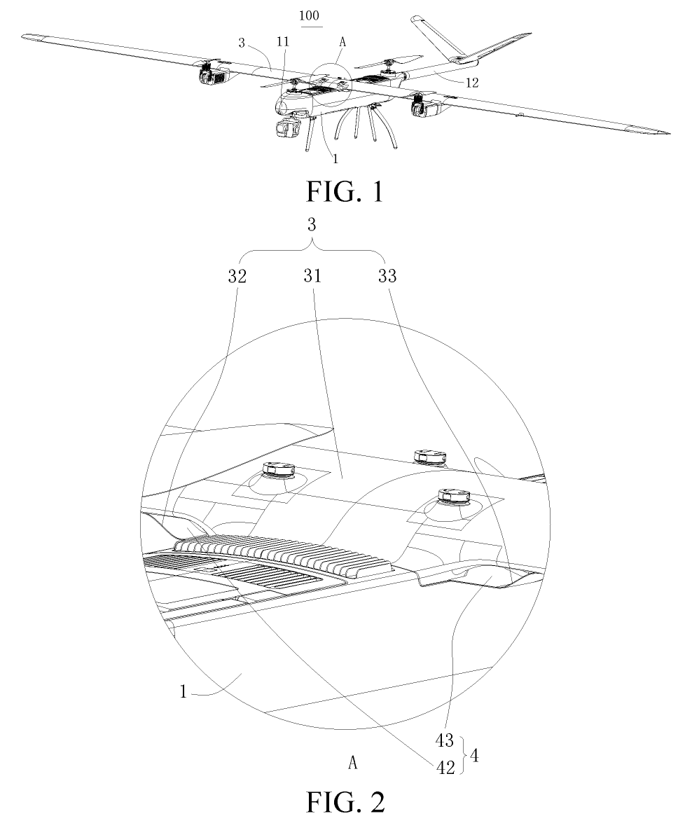

Referring to FIGS. 1, 2, and 5, an unmanned aerial vehicle (UAV) 100 includes a fuselage 1, a heat dissipation structure 2, and a wing assembly 3. The wing assembly 3 is mounted to the fuselage 1, forming a heat dissipation channel 4 in communication with the external environment such as atmosphere surrounding the UAV, ambient air outside the UAV, external airflow, or outside air. The heat dissipation structure 2 is mounted to the fuselage 1 and connected to at least some electronic devices within the fuselage 1, enabling heat transfer to the heat dissipation structure 2. At least part of the heat dissipation structure 2 is exposed to the heat dissipation channel 4, allowing airflow through the heat dissipation channel 4 to remove heat from the heat dissipation structure 2, thereby cooling the electronic devices in the fuselage 1.

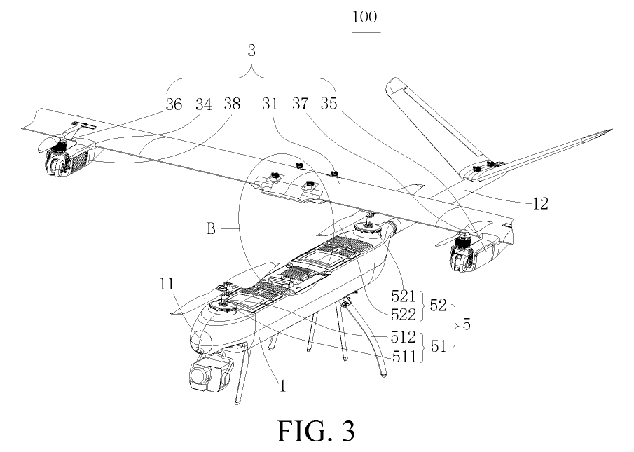

Referring to FIGS. 3, 4, and 5, the heat dissipation channel 4 includes an air venting channel 41 and a first air intake channel 42. The heat dissipation structure 2 is positioned in the air venting channel 41. The first air intake channel 42 communicates with the air venting channel 41, with an air inlet located at an end of the first air intake channel 42 away from the air venting channel 41. The air inlet is directed toward the head 11 of the UAV 100, allowing external air to enter the first air intake channel 42 without requiring a fan, thus simplifying the UAV structure and reducing energy consumption. The air outlet of the air venting channel 41 is located at an end opposite the first air intake channel 42 and faces the tail 12 of the UAV 100.

In some embodiments, referring to FIGS. 3, 4, and 5, the heat dissipation channel 4 includes a second air intake channel 43, which is in communication with the air venting channel 41 and is positioned on the opposite side of the fuselage 1 from the first air intake channel 42. The second air intake channel 43 allows additional airflow into the air venting channel 41, enhancing heat dissipation efficiency.

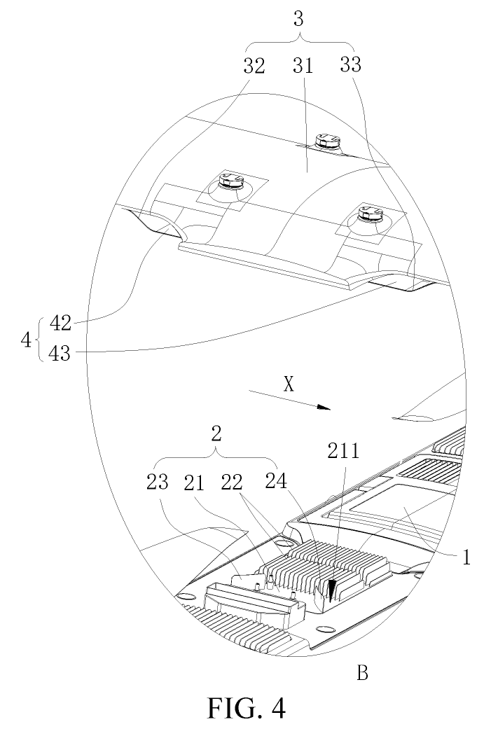

Referring to FIGS. 4, 5, and 6, the heat dissipation structure 2 includes a heat dissipation plate 21 and heat dissipation fins 22. The heat dissipation plate 21 is mounted to the fuselage 1 and connected to electronic devices within the fuselage 1. A first surface 211 of the heat dissipation plate 21 is exposed to the air venting channel 41, and the heat dissipation fins 22 are mounted to this surface. When airflow in the air venting channel 41 contacts the heat dissipation plate 21 and the heat dissipation fins 22, heat is removed, thereby cooling the UAV 100.

A plurality of heat dissipation fins 22 are mounted to the first surface 211 of the heat dissipation plate 21, spaced along a first direction X, which is perpendicular to the airflow in the air venting channel 41. This arrangement maximizes airflow exposure to the heat dissipation fins 22, enhancing heat dissipation efficiency while minimizing air resistance.

Referring to FIGS. 4 and 6, the heat dissipation structure 2 includes first and second flow guide plates 23 and 24, mounted to the first surface 211 of the heat dissipation plate 21. These guide plates direct airflow from the intake channels toward the heat dissipation fins 22, reducing turbulence and improving heat dissipation efficiency. The spacing between the guide plates gradually increases along the airflow direction, ensuring uniform cooling across the heat dissipation fins 22.

Referring to FIGS. 4 and 6, the wing assembly 3 includes a wing body 31, a first enclosing plate 32, and a second enclosing plate 33. These components define the boundaries of the first and second air intake channels 42 and 43. The enclosing plates feature streamlined transitional surfaces to reduce air resistance within the intake channels.

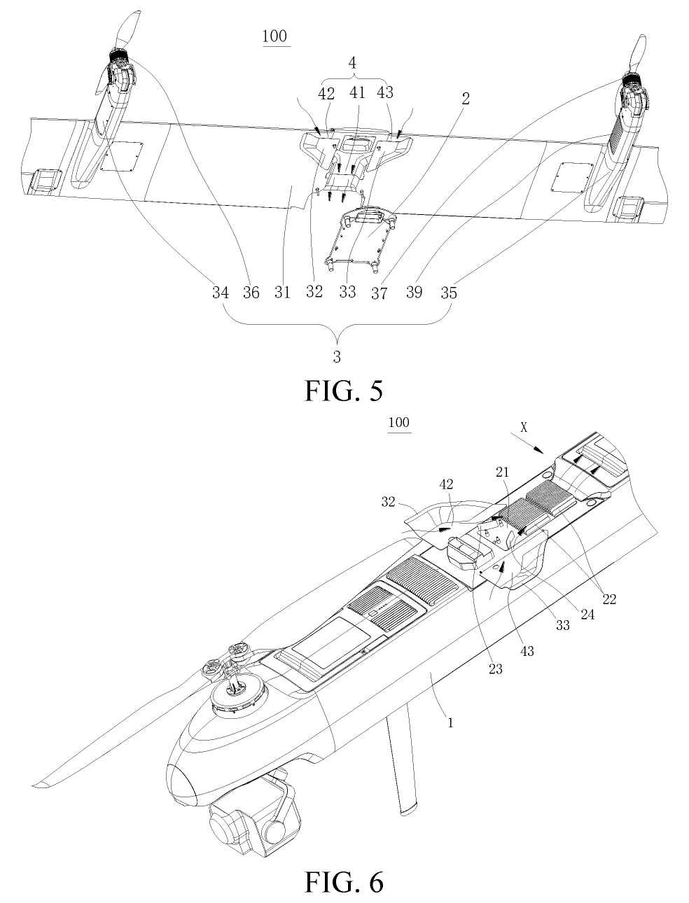

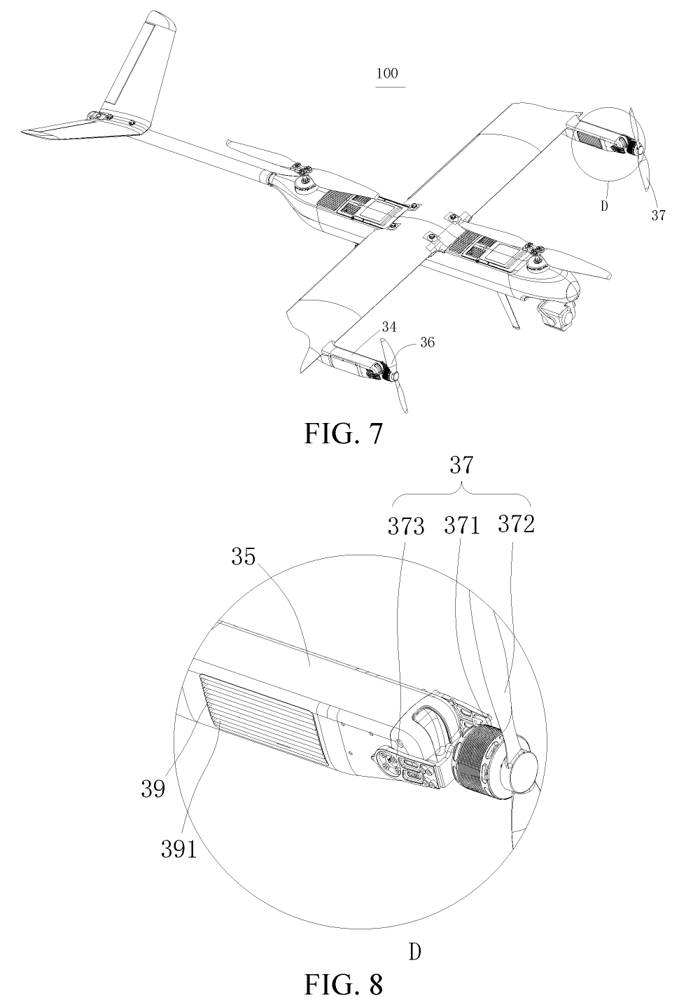

Referring to FIGS. 5 and 7, the wing assembly 3 includes first and second wing rods 34 and 35, first and second driving assemblies 36 and 37, and a lifting structure 5. The driving assemblies 36 and 37 can switch between horizontal and vertical states to provide thrust or lift for UAV flight control. Each driving assembly includes a motor, a rotor, a mounting bracket, and a switching motor that controls the rotor’s orientation.

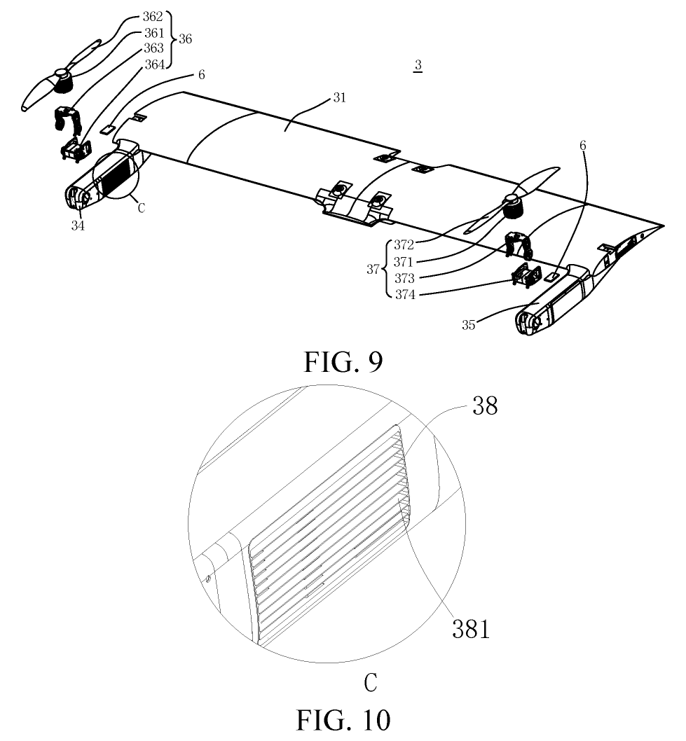

Referring to FIG. 9, the UAV 100 further includes first and second heat dissipation assemblies 38 and 39, mounted to the wing rods 34 and 35. These assemblies are connected to circuit boards in the wing rods and positioned to receive airflow from the rotors 362 and 372, improving cooling efficiency. Each heat dissipation assembly features grooves 381 and 391 to increase surface area and enhance heat dissipation. The grooves extend along the length of the wing rods, aligning with the rotor airflow for effective cooling.

Referring to FIG. 3, the lifting structure 5 includes third and fourth driving assemblies 51 and 52, each comprising a motor and a rotor. These components provide additional lift for UAV operation.

The heat dissipation structure 2 enables heat exchange between the UAV's electronic components and external air, ensuring optimal cooling performance. While specific embodiments have been described, modifications and equivalent implementations are within the scope of this disclosure. Any equivalent structures or process transformations using the principles described herein, or applications in related technical fields, fall within the protection scope of this disclosure.

What is claimed is:

1. An unmanned aerial vehicle (UAV), comprising:
a fuselage;
a wing assembly mounted to the fuselage; and
a heat dissipation structure connected to at least one electronic device in the fuselage;
wherein the fuselage and the wing assembly define a heat dissipation channel in communication with an external environment;
wherein at least a portion of the heat dissipation structure is exposed to the heat dissipation channel; and
wherein external air passing through the heat dissipation channel is configured to cool the heat dissipation structure when the UAV is in flight.

2. The UAV of claim 1, wherein:
the heat dissipation channel comprises an air venting channel and a first air intake channel;
the first air intake channel is in fluid communication with the air venting channel;
the heat dissipation structure is positioned within the air venting channel;
the first air intake channel comprises an air inlet in fluid communication with the external environment; and
the air inlet of the first air intake channel is oriented toward a forward direction of the UAV.

3. The UAV of claim 2, wherein:
the heat dissipation structure comprises a heat dissipation plate and at least one heat dissipation fin;
the heat dissipation plate is mounted to the fuselage and thermally coupled to the at least one electronic device;
at least a portion of the heat dissipation plate is exposed to the air venting channel; and
the heat dissipation fin is mounted to a surface of the heat dissipation plate that is oriented toward the heat dissipation channel.

4. The.UAV of claim 3, wherein:
a plurality of heat dissipation fins are arranged at intervals along a first direction; and
the first direction is not parallel to a flow direction of air in the air venting channel.

5. The UAV of claim 2, wherein:
the wing assembly comprises a wing body and a first enclosing plate;
the wing body is mounted to the fuselage;
the first enclosing plate is mounted to the wing body; and
the first enclosing plate and the wing body jointly define at least part of a boundary of the first air intake channel.

6. The UAV of claim 2, further comprising:
a second air intake channel in communication with the air venting channel;
wherein the second air intake channel has an air inlet in communication with the external environment;
wherein the air inlet of the second air intake channel is oriented toward a forward direction of the UAV; and
wherein the first air intake channel and the second air intake channel are positioned on opposite sides of the fuselage.

7. The UAV of claim 6, wherein:
the wing assembly further comprises a second enclosing plate;
the wing body is mounted to the fuselage;
the second enclosing plate is mounted to the wing body; and
the wing body and the second enclosing plate jointly define at least part of a boundary of the second air intake channel.

8. The UAV of claim 6, wherein:
the heat dissipation structure comprises a first flow guide plate positioned within the air venting channel; and
a first end of the first flow guide plate is joined to an air outlet of the first air intake channel, thereby directing at least a portion of airflow from the first air intake channel into the air venting channel.

9. The UAV of claim 8, wherein:
the heat dissipation structure further comprises a second flow guide plate positioned opposite to the first flow guide plate; and
a first end of the second flow guide plate is joined to an air outlet of the second air intake channel, thereby directing at least a portion of airflow from the second air intake channel into the air venting channel.

10. The UAV of claim 9, wherein:
a spacing distance between the first flow guide plate and the second flow guide plate gradually increases from one end to an opposite end of the first flow guide plate.
